(19) United States
(12) Patent Application Publication
(10) Pub. No.: US 2002/0184303 A1
(43) Pub. Date: Dec. 5, 2002

(54) Embedded web server capable of managing dynamic content delivery of data stream, audio stream, or video stream

(75) Inventor: Eric R. Uner, Carpentersville, IL (US)

Correspondence Address: Charles F. Meroni, Jr., Meroni & Meroni, A Professional Corporation, P.O. Box 309, Barrington, IL, 60011, US

(73) Assignee: Virtaul Media, Inc.

(21) Appl. No.: 09/871,140

(22) Filed: May 31, 2001

(51) Int. Cl. G06F 15/16

(52) U.S. Cl. 709/203

(57) ABSTRACT

An embedded web server, which is capable of managing dynamic content delivery of data stream, audio stream, or video stream, comprises a microprocessor, a memory, a network port, a dynamic internet streaming engine, a security key generating application which is capable of generating security keys, an embedded web server housing which houses said microprocessor, said memory, said network port, said dynamic internet streaming engine, and said security key generating application, and an object-oriented language which is understood and used by said embedded web server.

### BACKGROUND OF THE INVENTION

1. Field of the Invention

The present invention relates to embedded web server technology. More specifically, my invention is primarily intended for an embedded web server capable of managing dynamic content delivery of data stream, audio stream, or video stream.

2. Description of the Prior Art

Specialized computers known as “server appliances” are quickly replacing complex all-purpose machines as web servers. The business paradigm is from Cisco Systems Inc., who revolutionized communications with the router, a specialized computer that moves data around networks. Network Appliance, Inc. is a founder of so-called server appliances. The traditional general-purpose servers are built to handle dozens of tasks at once. However, server appliances are built to perform one job quickly and simply. A server appliance designed for web hosting will not crunch numbers as fast as a big general-purpose machine. However, that streamlined web-hosting server can dish out web pages faster than traditional servers costing three times as much. Also, storage servers allow users anywhere on a network to store and retrieve files faster than traditional devices; caching appliances keep popular web pages in close proximity to web servers, which can cut download time by 80%.

A monumental shift in the way technology is delivered is driving the popularity of these server appliances. Instead of using massive computers in their offices, corporations can now buy computing power from other companies via the web. These companies house the computers and the problems, dishing up applications software as its needed to perform specific tasks. But for this new technology-on-tap to work, the web must be as reliable as the phone system. That will fuel demand for single-purpose devices that can handle tasks without the breakdowns or sluggish performance that plague multifunction computers. By incorporating these server appliances to big, general-purpose machines, the overall performance of online networks can be improved significantly.

Various inventions have been made to provide an embedded web server to the server market. U.S. Pat. No. 5,956,487, which issued to Venkatraman, et al., discloses an Embedding Web Access Mechanism in an Appliance for User Interface Functions Including a Web Server and Web Browser. This invention provides a solution for widely accessible, low cost, and enhanced user interface functions for a device. The solution involves embedding web access functionality into the device including a web server that provides a device web page. The device includes an embedded network interface that enables access to the device web page by a web browser. A user of the web browser accesses the user interface functions for the device through the device web page. The web server functionality may be implemented with existing circuitry in a device, such as an exiting processor, memory, and input/output circuitry that normally perform device-specific functions, thereby avoiding the extra cost and space required for dedicated web server hardware for the device. The web server functionality embedded in the device enables the device user interface access via a variety of communication mechanisms including the world wide web portion of the Internet. The costs of providing screen based user interface mechanisms are exported away from the device and do not require an external computer to provide a device web server. The methods and mechanisms disclosed herein provide screen based user-friendly interfaces to a wide variety of devices without the necessity to develop expensive hardware and software applications for differing devices. The methods and mechanisms employ web technology so that access to a device user interface is independent of the computer system platform employed, independent of the web browser software executed, and independent of the location of the user. The user interface information is packaged using he Hyper-Text Markup Language (HTML) and is transported according to the Hyper-Text Transfer Protocol (HTTP). The HTML and HTTP protocols enable communication with existing web browsers independent of the platform that executes the web browser. The present techniques avoid the need of an industry-wide Application Programming Interface (API) to unify the control and use of equipment.

U.S. Pat. No. 5,973,696, which issued to Agranat, et al., discloses an Embedded Web Server. The invention provides an improved graphical user interface (GUI) for use in connection with remote control, management, configuration, monitoring and diagnosing functions embedded in applications, devices and equipment. The invention also provides a method for providing a graphical user interface having dynamic elements. The method begins by defining elements of the graphical user interface in at least one text document written in a mark-up language. Next, the method defines including at a location in the document, a code tag containing a segment of application source code. The text document is then served to a client, which interprets the mark-up language; and when the location is encountered, the client is served a sequence of characters derived from a result of executing a sequence of instructions represented by the segment of application source code. An embodiment of code tags illustrating their use is later described in detail herein. The invention further provides another method for providing a graphical user interface having dynamic elements. This method also defines elements of the graphical user interface in at least one text document written in a mark-up language. Included in the document is a string identified by prototype tags. The text document is served to a prototyping client which interprets the mark-up language but does not recognize and does not display the prototype tag, but does display the string. An embodiment of prototype tags illustrating their use is described in detail hereafter. The invention still further provides another method for providing a graphical user interface having dynamic elements. Elements of the graphical user interface are defined in at least one text document written in a mark-up language. Included at a location in the document is a code tag containing a segment of application source code. Also included in the document is a string identified by prototype tags. The text document is compiled into a content source, which is subsequently decompiled into a replica of the text document. The replica of the text document is served to a client which interprets the mark-up language; when the location is encountered in the replica, the client is served a character stream generated by executing the segment of application source code. The invention further provides a software product recorded on a medium. The software product includes a mark-up language compiler which can compile a mark-up language document into a data structure in a native application programming language, the compiler recognizing one or more code tags which designate included text as a segment of application source code to be saved in a file for compilation by a compiler of the native application programming language. The invention still further provides a method for providing a graphical user interface having displayed forms for entry of data. The steps of this method include defining elements of the graphical user interface in at least one text document written in a mark-up language; naming in the document a data item requested of a user and used by an application written in a native application programming language; and compiling the text document into a content source including a data structure definition in the native application programming language for the named data item. The invention may be practiced in a computer-based apparatus for developing a graphical user interface for an application, the apparatus including an editor which can manipulate a document written in a mark-up language and a viewer which can display a document written in the mark-up language. The apparatus further includes a mark-up language compiler which recognizes a code tag containing a source code fragment in a native application source code language, the code tag not otherwise part of the mark-up language, the compiler producing as an output a representation in the native application source code language of the document, including a copy of the source code fragment.

U.S. Pat. No. 6,170,007, which issued to Venkatraman, et al., discloses an Embedding Web Access Functionality into a Device for User Interface Functions. Web access functionality is embedded in a device to enable low cost widely accessible and enhanced user interface functions for the device. A web server in the device provides access to the user interface functions for the device through a device web page. A network interface in the device enables access to the web page by a web browser such that a user of the web browser accesses the user interface functions for the device through the web page.

Although these patents disclose different embedded web servers, none of the patents teach how to provide an embedded web server with high performance and running without an operating system. The current invention is an embedded web server capable of managing dynamic content delivery of data stream, audio stream, or video stream. The current invention is a high performance, secured, and embedded web server.

The business world is now experiencing a big shift from traditional ways of business commerce to web-based transactions conducted in real-time electronic marketplaces between buyers and sellers. Technology is becoming more important to companies of all sizes and in all industries, and there has been an increased drive to implement Internet solutions. The trends point to a new era in outsourced solutions where there is greater acceptance of standardized critical functions across multiple companies and whole industries. This will accelerate the speed to market and the ability to achieve economies of scale. Deregulation, globalization, and technological innovation are accelerating the rate of change in business.

Organizations face constant pressures to improve the quality of their products and services, reduce cost and time to market, enhance operating efficiencies, and strengthen customer relationships. These pressures are compelling business managers to streamline their processes and improve the flow of information both internally and externally. Businesses are spending more money on infrastructure. Explosive volume gains and the drive among enterprises of all classes to implement Internet and business solutions are the prime factors fueling the growth of the Internet infrastructure.

As businesses implement their Internet, a higher level of quality of service and reliability will be expected. This demand for quality should further drive the demand for technology products and services, with infrastructure being among the most critical components of this spending. For this to work, all information systems of an enterprise must be integrated to enable information to pass seamlessly across the enterprise.

Due to the increased need for better connectivity, more servers, and more Internet-enabling devices, there has been huge growth in more specialized devices upon which numerous technologies are converging. Many of these involved multimedia and Internet connectivity. There has been heightened interest in the evaluation of embedded Internet products and technology worldwide. As increasingly more dynamic content is demanded over the Internet, enterprises with intensive online business will need high-performing, reliable, scalable, and secure web servers and services to support their business.

As a result of all these needs, what is needed then is a secured embedded web server capable of managing dynamic content delivery of data stream, audio stream, or video stream.

Accordingly, it is a principal object of my invention to provide an embedded web server that is capable of managing dynamic content delivery of data stream, audio stream, or video stream.

It is a further object of my invention to provide an embedded web server that is secured and hacker proof.

It is a further object of my invention to provide an embedded web server that is capable of running high-performance electronic commerce web sites.

It is a still further object of my invention to provide an embedded web server that is capable of embedding and securing data, content, protocols and scripts.

It is a further object of my invention to provide an embedded web server that is capable of delivering real time response.

It is a further object of my invention to provide an embedded web server that is capable of operating without an operating system

It is a further object of my invention to provide an embedded web server that is capable of running without human intervention once an initial configuration is completed.

### SUMMARY OF THE INVENTION

According to my present invention I have provided an embedded web server capable of managing dynamic content delivery of data stream, audio stream, or video stream. The embedded web server comprises a microprocessor, a memory, a network port, a dynamic internet streaming engine, a security key generating application capable of generating security keys, and an object-oriented language. The embedded web server is capable of functioning as a web server. The embedded web server is capable of running high-performance electronic commerce web sites. The embedded web is also capable of embedding and securing data, content, protocols and scripts. The embedded web server is further capable of delivering real time response. The embedded web server is capable of operating without an operating system. The embedded web server is capable of creating a template. The template is then compiled and loaded into said embedded web server. The template is capable of specifying protocol, content, data, and being a scripting language to translate inbound requests. As soon as the embedded web server is completed for the initial configuration, it is capable of running without human intervention. The dynamic internet streaming engine of the embedded web server is specifically designed to facilitate rapid application development and web site prototyping. The dynamic internet streaming engine includes IP level security features. The dynamic internet streaming engine also allows developers to quickly add or change features without the need for code changes. The dynamic internet streaming engine is capable of enabling said embedded web server to deliver dynamic text and binary data stream editing for performing complex actions and making interactive web. The dynamic internet streaming engine is also capable of propagating changes made in one place instantly to thousands of files. The dynamic internet streaming engine is further capable of compiling code directly into HTML. The dynamic internet streaming engine is capable of facilitating rapid application development and web site prototyping. The security key generating application of the embedded web server is capable of generating security keys based on both a mathematical and biological equation. The security keys generated by the security key generating application are guaranteed to be unique and random. The object-oriented language used by the embedded web server allows access to preprocess directives from both C++ code and HTML code.

### DESCRIPTION OF THE DRAWINGS

Other objects of my invention, as well as particular features, elements, and advantages thereof, will be elucidated in, or apparent from, the following description and the accompanying drawing figures.

Other features of my invention will become more evident from a consideration of the following detailed description of my patent drawings, as follows:

FIG. 1 is a preferred embodiment of an embedded web server;

FIG. 2 is a flow diagram of the operating process of the embedded web server;

FIG. 3 illustrates of the security sub system;

FIG. 4 shows functional structure of the embedded web server;

FIG. 5 demonstrates the operational relationship between the real time executor and other part of the embedded web server;

FIG. 6 portrays the operational relationship between the board support package and other part of the embedded web server;

FIG. 7 illustrates the operational relationship between the embedded memory manager and other part of the embedded web server;

FIG. 8 discloses the operational relationship between the object-oriented language and other part of the embedded web server; and

FIG. 9 further discloses the operational relationship between the device interface and other part of the embedded web server.

### DETAILED DESCRIPTION OF THE PREFERRED EMBODIMENT

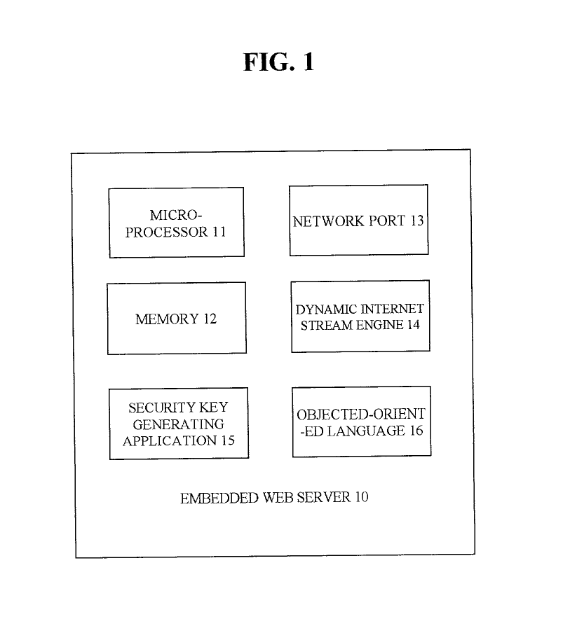

FIG. 1 is a preferred embodiment of an embedded web server 10 capable of managing dynamic content delivery of data stream, audio stream, or video stream. Said embedded web server 10 comprises a microprocessor 11, a memory 12, a network port 13, a dynamic internet streaming engine 14, a security key generating application 15 and an object-oriented language 16.

The dynamic internet streaming engine 14 is capable of enabling said embedded web server 10 to deliver dynamic text and binary data stream editing for performing complex actions and making interactive web. Propagating changes made in one place by the dynamic internet streaming engine 14 will be instantly passed over to thousands of files. The dynamic internet streaming engine 14 is capable of compiling code directly into HTML, and facilitating rapid application development and web site prototyping.

The security key generating application 15 is capable of generating security keys based on both a mathematical and biological equation. The mathematical and biological equation can guarantee the uniqueness and randomness of the security.

The object-oriented language 16 used by said embedded web server 10 allows access to preprocess directives from both C++ code written by a developer and HTML code written by a graphic artist or web designer. Therefore, it will make the communication between web developer and web designer or a graphic artist very easy and effective.

The embedded web server 10 can be used as a static page web server, a dynamic page web server, a random session ID or sequence number generator server, a caching device, a secure server (https server), a web server, a content acceleration server, an internet standard file transfer protocol (FTP) server. The embedded web server 10 can be used to run E-Commerce applications, such as data warehousing, credit card transaction processing, etc.

The embedded web server 10 is capable of running high-performance electronic commerce web sites, embedding and securing data, content, protocols and scripts, delivering real time response, functioning as a web server, operating without an operating system and running without human intervention once an initial configuration is completed.

The embedded web server 10 is capable of creating a template, which is then compiled and loaded into said embedded web server 10. Said template is capable of specifying protocol, content, data, and being a scripting language to translate inbound requests.

The dynamic internet streaming engine 14 is specifically designed to facilitate rapid application development and web site prototyping. The dynamic internet streaming engine 14 includes IP level security features. The dynamic internet streaming engine 14 allows developers to quickly add or change features without the need for code changes.

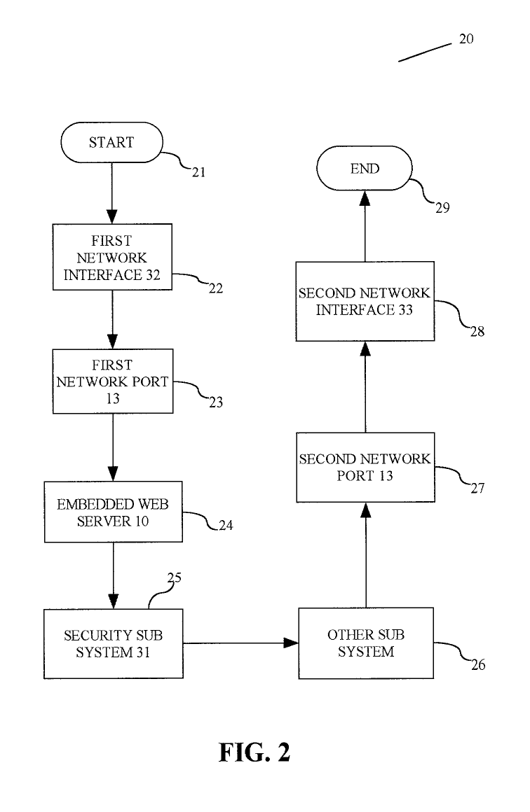

Referring now to FIG. 2, which is a flow diagram of a operating process of the embedded web server 10. The operating process starts at block 21 and proceeds to block 22, which is a first network interface 32. The first network interface 32 is the interface for all the incoming data to go into embedded web server 10. The operating process proceeds to block 23, which is the network port 13, where the incoming data enters the embedded web server 24. The operating process proceeds to block 24, where the data is processed by the embedded web server 10. The operating process proceeds to block 25, which is a security sub-system 31. The security sub-system 31 runs a security key generating application 15 to generate session identifiers that are random and never repeating. The operating process proceeds to block 26, which represents other subsystems required by the process, where it will perform all the functions of a web server, but at a high speed, and generate outgoing data. Block 26 may include various kinds of subsystems, including FTP, HTTP static pages or dynamic pages, security sub-system similar to the security sub-system 31, or the like. The operating process then proceeds to block 27, where the outgoing data goes out through a second network port 13. The operating process then proceeds to block 28, where the outgoing data goes back to a second network interface 33. The operating process proceeds to block 29 and ends right there. The first network port 13 and the second network port 13 can be the same network port 13. The first network interface 32 and the second network interface 33 can be the same network interface 33.

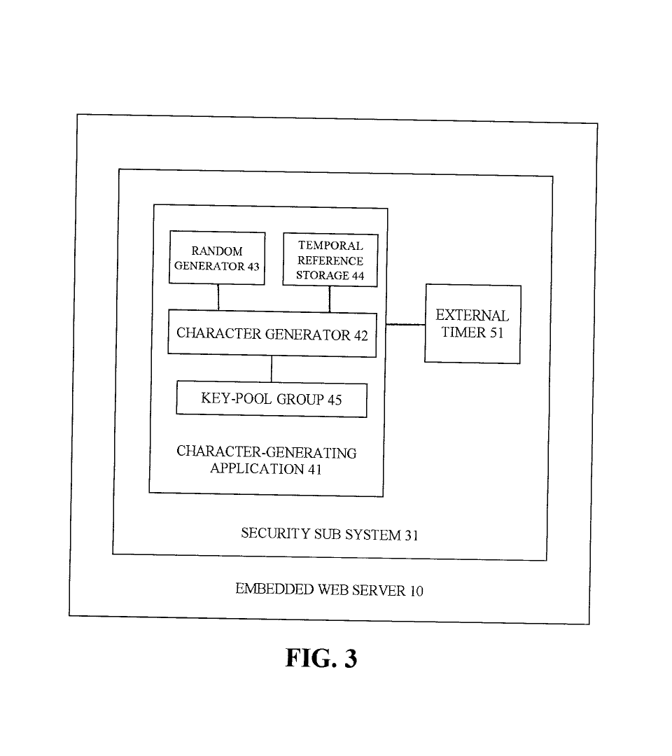

Referring to FIG. 3, which shows the details of the security sub system 31 to generate session identifiers. The security sub system 31 is a means for producing a session identifier 40. The means for producing said session identifier 40 is capable of generating said session identifiers, which are never repeating within a certain period of time and difficult to guess. The means for producing said session identifier 40 comprises a character-generating application 41 and an external timer device 51. The external timer device 51 connects to the character-generating application 41 and is capable of providing both a current time and a periodic tick to the character-generating application 41. The character-generating application 41 exists as a single task in the embedded web server 10. The character-generating application 41 comprises a character generator 42, a random generator 43 connecting to the character generator 42, a temporal reference storage 44 connecting to the character generator, the temporal reference storage 44 storing the most current time information, and a key-pool group 45 connecting to the character generator, the key-pool group 45 including any or all of a first kind of key with a first kind of pool, a second kind of key with a second kind of pool, and a third kind of key with a third kind of pool. The character generator 42 is capable of generating a character set, the character set having thirty-two different characters, based on a geometric progression of x(n)=p(x(n−1)+i), the geometric progression manifesting itself as a chaotic progression of orbits around an origin, the orbit being defined as a unique and continuous path around the origin and never crossing in on itself or any other orbit, the x(n) and the x(n−1) representing different character sets, the n representing the number of the character sets generated by the character-generating server, the i representing a temporal difference between the time when two sequential orbits cross an arbitrary infinite vector from the origin, the p representing a period, the period being the temporal difference between character sets along any of the orbits, the geometric progression defining thirty-two periods on any of the orbit, the character set being a first kind of character set, a second kind of character set or a third kind of character set.

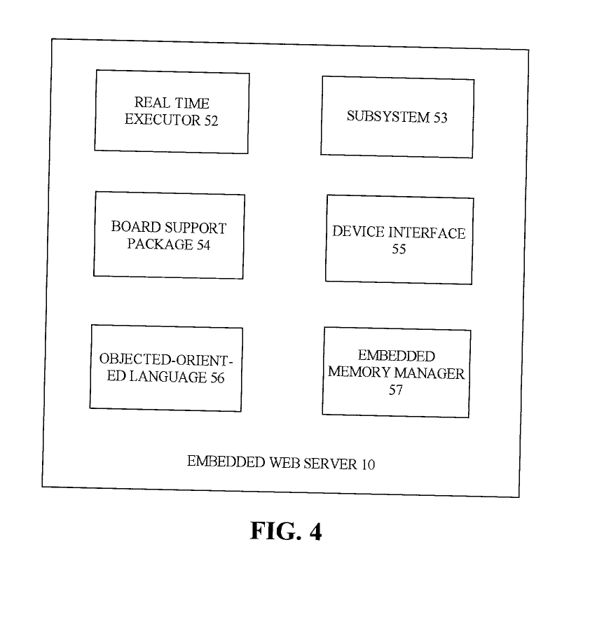

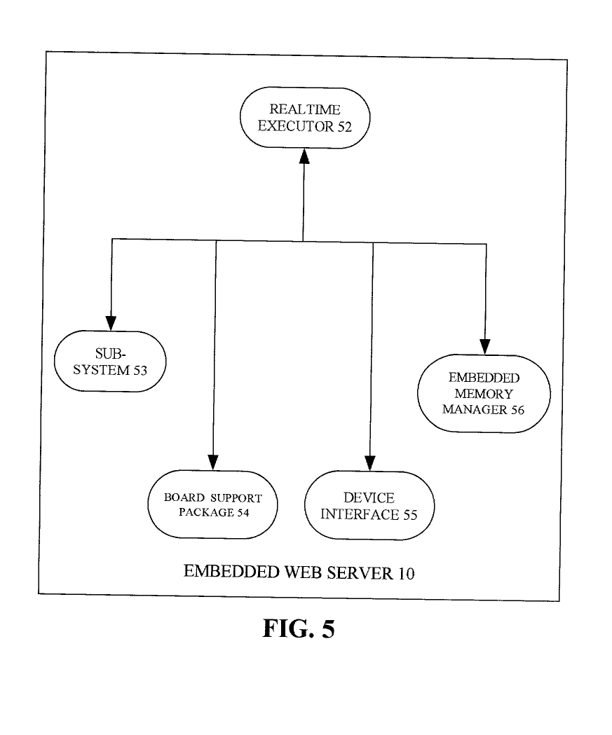

Referring now to FIG. 4, which is a functional structure of the embedded web server 10. The embedded web server 10 has seven functional parts, including a real time executor 52, subsystem 53, board support package 54, device interface 55, an object-oriented language 56, embedded memory manager 57, and information storage interface 58. FIGS. 5-9 demonstrates how these functional parts are related to each other.

Referring now to FIG. 5, which demonstrates the operational relationship between the real time executor 52 and four of the other six functional parts, including subsystem 53, board support package 54, device interface 55, and object-oriented language 56. During the operation of the embedded web server 10, the real time executor 52 might communicate to various subsystems 53 to perform various functions of a web server. The real time executor 52 may also communicate to the board support package 54 to get various support it needs to operate. The real time executor 52 may also communicate to the device interface 55 to communicate to the outside of the embedded web server 10. The real time executor 52 may also use the object-oriented language 56 to perform various functions.

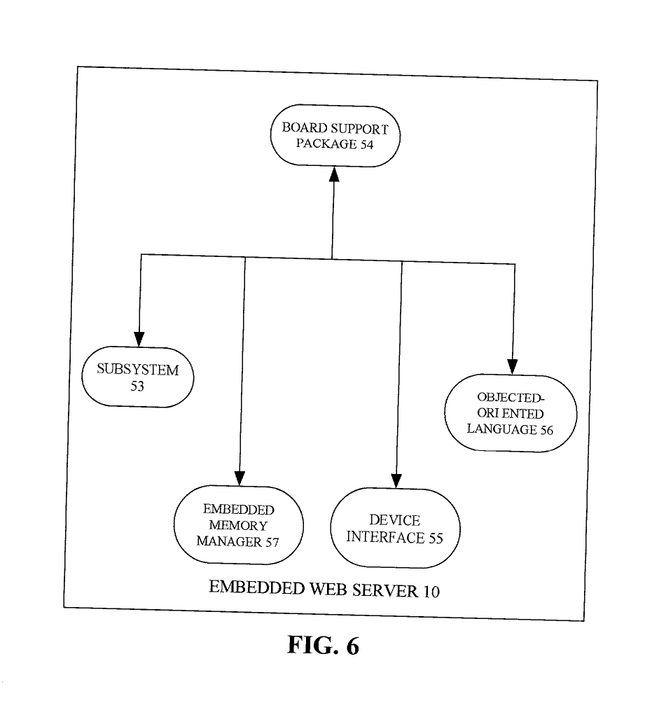

Referring now to FIG. 6, which demonstrates the operational relationship between the board support package 54 and four of the other six functional parts, including subsystem 53, embedded memory manager 57, device interface 55, and object-oriented language 56. During the operation of the embedded web server 10, the board support package 54 might communicate to various subsystem 53 back and force to support the need of various subsystem 53. The board support package 54 might also communicate to the embedded memory manager 57 to support its function. The board support package 54 might also communicate to device interface 55 to support its operation. The board support package 54 might also communicate with the object-oriented language during the operation of the embedded web server 10.

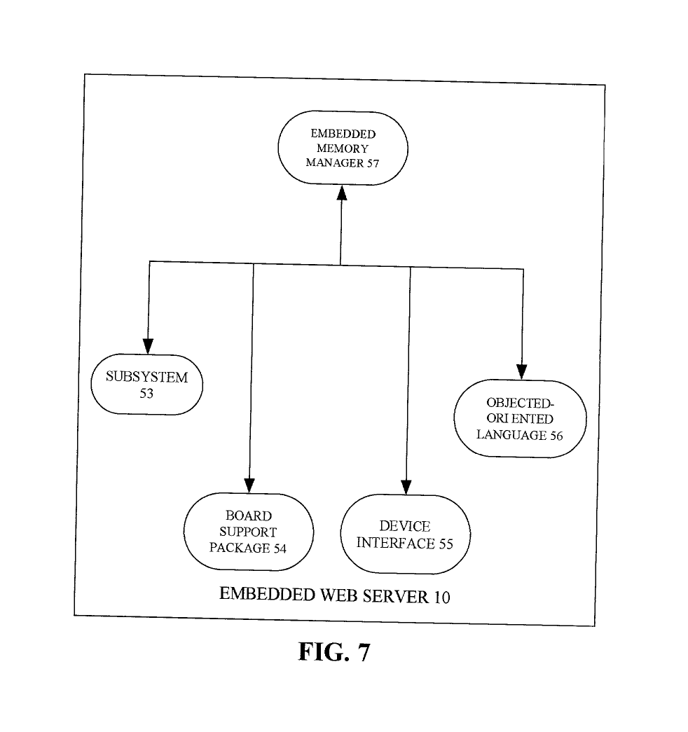

Referring now to FIG. 7, which demonstrates the operational relationship between the embedded memory manager 57 and four of the other six functional parts, including subsystem 53, board support package 54, device interface 55 and the object-oriented language 56. During the operation of the embedded web server 10, the embedded memory manager 57 communicates to various subsystem 53, board support package 54, device interface 55 and the object-oriented language 56 to provide the necessary memory management function.

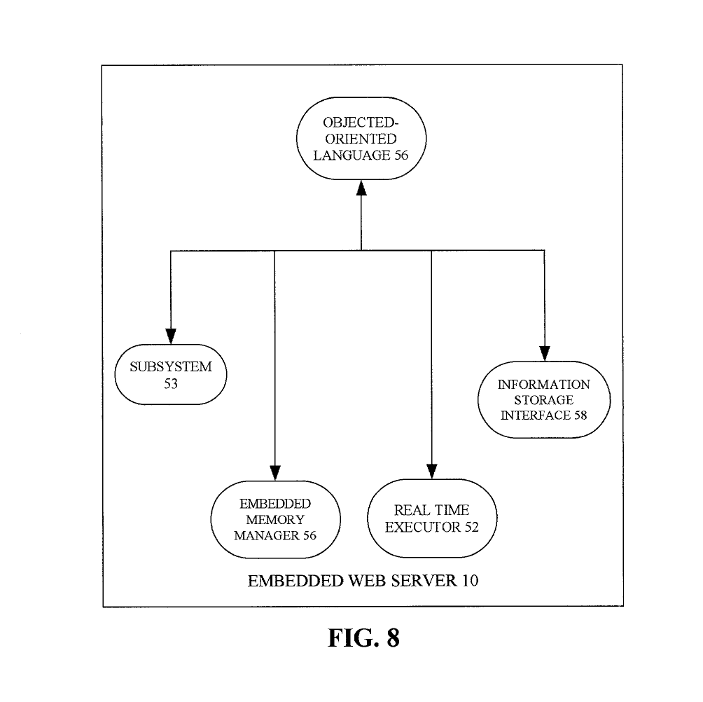

Referring now to FIG. 8, which demonstrates the operational relationship between the object-oriented language 56 and four of the other six functional parts. The six functional parts are the subsystem 53, the embedded memory manager 57, the real time executor 52 and the information storage interface 58. During the operation of the embedded web server 10, the object-oriented language 56 provides all the language function and support for the needs from the subsystem 53, embedded memory manager 57, real time executor 52 and information storage interface 58.

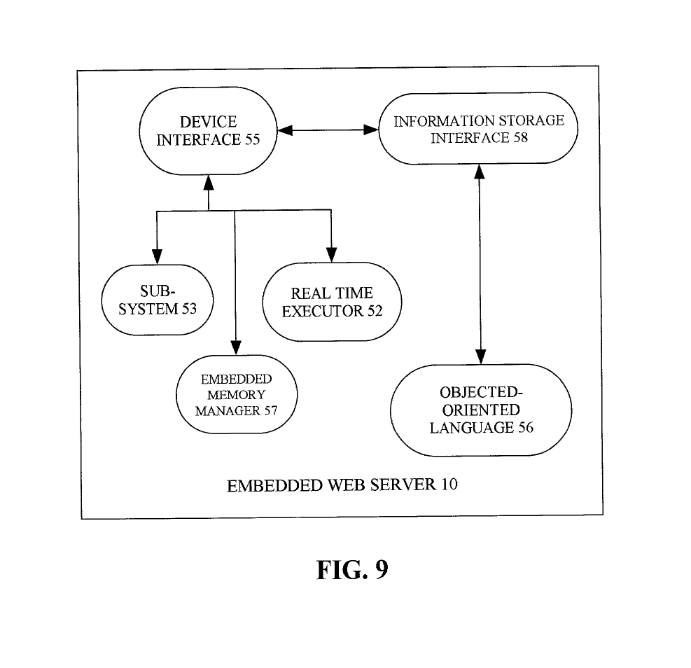

Referring now to FIG. 9, which demonstrates the operational relationship between the device interface 55 and five of the other six functional parts. The six functional parts are the subsystem 53, the embedded memory manager 57, the real time executor 52, the information storage interface 58 and the object-oriented language 56. The device interface 55 communicates to the object-oriented language 56 through the information storage interface 58. The device interface 55 also communicates to the subsystem 53, embedded memory manager 57, and the real time executor 52 during the operation of the embedded web server 10.

Different functional parts of the embedded web server 10 are integrated into the embedded web server 10 to make the embedded web server 10 more powerful and efficient than a web servers.

Hence, my current invention provides an embedded web server that is capable of managing dynamic content delivery of data stream, audio stream, or video stream.

My current invention also provides the following new and improved features:

1. an embedded web server that is secured and hacker proof;

2. an embedded web server that is capable of running high-performance electronic commerce web sites;

3. an embedded web server that is capable of embedding and securing data, content, protocols and scripts;

4. an embedded web server that is capable of delivering real time response;

5. an embedded web server that is capable of operating without an operating system; and

6. an embedded web server that is capable of running without human intervention once an initial configuration is completed.

As various possible embodiments may be made in the above invention for use for different purposes and as various changes might be made in the embodiments and methods above set forth, it is understood that all of the above matters here set forth or shown in the previously described accompanying drawings are to be interpreted as illustrative and not in a limiting sense.

I claim:

1. An embedded web server capable of managing dynamic content delivery of data stream, audio stream, or video stream, said embedded web server comprising:
a microprocessor;
a memory, said memory connected to said microprocessor;
a network port, said network port connected to said microprocessor;
a dynamic internet streaming engine for XML, HTML and raw data, said dynamic internet streaming engine, connected to said microprocessor, capable of enabling said embedded web server to deliver dynamic text and binary data stream editing for performing complex actions and making interactive web, propagating changes made in one place instantly to thousands of files, compiling code directly into HTML, and facilitating rapid application development and web site prototyping;
a security key generating application, said security key generating application, connected to said microprocessor, capable of generating security keys based on a mathematical and biological equation, said mathematical and biological equation guaranteeing said security keys being unique and random; and
an object-oriented language, said object-oriented language, understood by said microprocessor, allowing access to preprocess directives from both C++ code written by a developer and HTML code written by a graphic artist or web designer.

2. The embedded web server in claim 1, wherein said embedded web server is capable of running high-performance electronic commerce web sites.

3. The embedded web server in claim 1, wherein said embedded web server is capable of embedding and securing data, content, protocols and scripts.

4. The embedded web server in claim 1, wherein said embedded web server is capable of delivering real time response.

5. The embedded web server in claim 1, wherein said embedded web server is capable of functioning as a web server.

6. The embedded web server in claim 1, wherein said embedded web server is capable of operating without an operating system.

7. The embedded web server in claim 1, wherein said embedded web server is capable of creating a template, said template being then compiled and loaded into said embedded web server, said template capable of specifying protocol, content, data, and being a scripting language to translate inbound requests.

8. The embedded web server in claim 1, wherein said embedded web server is capable of running without human intervention once an initial configuration being completed.

9. The embedded web server in claim 1, wherein said dynamic internet streaming engine is specifically designed to facilitate rapid application development and web site prototyping.

10. The embedded web server in claim 1, wherein said dynamic internet streaming engine includes IP level security features.

11. The embedded web server in claim 1, wherein said dynamic internet streaming engine allows developers to quickly add or change features without the need for code changes.

12. An embedded web server capable of managing dynamic content delivery of data stream, audio stream, or video stream, said embedded web server comprising:
a microprocessor;
a memory;
a network port;
a dynamic internet streaming engine;
a security key generating application capable of generating security keys;
an embedded web server housing, said microprocessor, said memory, said network port, said dynamic internet streaming engine, and said security key generating application all being disposed within said embedded web server housing; and
an object-oriented language, said object-oriented language understood and used by said embedded web server.

13. The embedded web server in claim 12, wherein said embedded web server is capable of running high-performance electronic commerce web sites.

14. The embedded web server in claim 12, wherein said embedded web server is capable of embedding and securing data, content, protocols and scripts.

15. The embedded web server in claim 12, wherein said embedded web server is capable of delivering real time response.

16. The embedded web server in claim 12, wherein said embedded web server is capable of functioning as a web server.

17. The embedded web server in claim 12, wherein said embedded web server is capable of operating without an operating system.

18. The embedded web server in claim 12, wherein said embedded web server is capable of creating a template, said template being then compiled and loaded into said embedded web server, said template capable of specifying protocol, content, data, and being a scripting language to translate inbound requests.

19. The embedded web server in claim 12, wherein said embedded web server is capable of running without human intervention once an initial configuration is completed.

20. The embedded web server in claim 12, wherein said dynamic internet streaming engine is specifically designed to facilitate rapid application development and web site prototyping.

21. The embedded web server in claim 12, wherein said dynamic internet streaming engine includes IP level security features.

22. The embedded web server in claim 12, wherein said dynamic internet streaming engine allows developers to quickly add or change features without the need for code changes.

23. The embedded web server in claim 12, wherein said dynamic internet streaming engine is capable of enabling said embedded web server to deliver dynamic text and binary data stream editing for performing complex actions and making interactive web.

24. The embedded web server in claim 12, wherein said dynamic internet streaming engine is capable of propagating changes made in one place instantly to thousands of files.

25. The embedded web server in claim 12, wherein said dynamic internet streaming engine is capable of compiling code directly into HTML.

26. The embedded web server in claim 12, wherein said dynamic internet streaming engine is capable of facilitating rapid application development and web site prototyping.

27. The embedded web server in claim 12, wherein said security key generating application is capable of generating security keys based on a mathematical and biological equation.

28. The embedded web server in claim 12, wherein said security keys are guaranteed to be unique and random.

29. The embedded web server in claim 12, wherein said object-oriented language allows access to preprocess directives from both C++ code and HTML code.

30. An embedded web server capable of managing dynamic content delivery of data stream, audio stream, or video stream, said embedded web server comprising:
a microprocessor;
a memory, said memory connected to said microprocessor;
a network port, said network port connected to said microprocessor;
a dynamic internet streaming engine, said dynamic internet streaming engine controlled by said microprocessor;
a security key generating application, said security key generating application controlled by said microprocessor capable of generating security keys; and
an object-oriented language, said object-oriented used by said microprocessor.

31. The embedded web server in claim 30, wherein said dynamic internet streaming engine is specifically designed to facilitate rapid application development and web site prototyping.

32. The embedded web server in claim 31, wherein said dynamic internet streaming engine includes IP level security features.

33. The embedded web server in claim 32, wherein said dynamic internet streaming engine allows developers to quickly add or change features without the need for code changes.

34. The embedded web server in claim 33, wherein said dynamic internet streaming engine is capable of enabling said embedded web server to deliver dynamic text and binary data stream editing for performing complex actions and making interactive web.

35. The embedded web server in claim 34, wherein said dynamic internet streaming engine is capable of propagating changes made in one place instantly to thousands of files.

36. The embedded web server in claim 35, wherein said dynamic internet streaming engine is capable of compiling code directly into HTML.

37. The embedded web server in claim 36, wherein said dynamic internet streaming engine is capable of facilitating rapid application development and web site prototyping.

38. The embedded web server in claim 37, wherein said embedded web server is capable of running high-performance electronic commerce web sites.

39. The embedded web server in claim 38, wherein said embedded web server is capable of embedding and securing data, content, protocols and scripts.

40. The embedded web server in claim 39, wherein said embedded web server is capable of delivering real time response.

41. The embedded web server in claim 40, wherein said embedded web server is capable of functioning as a web server.

42. The embedded web server in claim 41, wherein said embedded web server is capable of operating without an operating system.

43. The embedded web server in claim 42, wherein said embedded web server is capable of creating a template, said template being then compiled and loaded into said embedded web server, said template capable of specifying protocol, content, data, and being a scripting language to translate inbound requests.

44. The embedded web server in claim 43, wherein said embedded web server capable of running without human intervention once an initial configuration is completed.

45. The embedded web server in claim 30, wherein said security key generating application is capable of generating security keys based on a mathematical and biological equation.

46. The embedded web server in claim 45, wherein said security keys are guaranteed to be unique and random.

47. The embedded web server in claim 30, wherein said object-oriented language allows access to preprocess directives from both C++ code and HTML code.

48. An embedded device capable of managing dynamic content delivery of data stream, audio stream, or video stream, said embedded device comprising:
a microprocessor;
a memory, said memory connected to said microprocessor;
a network port, said network port connected to said microprocessor;
a dynamic internet streaming engine, said dynamic internet streaming engine connected to said microprocessor;
a security key generating application capable of generating security keys, said security key generating application connected to said microprocessor; and
an object-oriented language, said object-oriented language understood by said microprocessor.

49. The embedded device in claim 48, wherein said embedded device is capable of running high-performance electronic commerce web sites.

50. The embedded device in claim 48, wherein said embedded device is capable of embedding and securing data, content, protocols and scripts.

51. The embedded device in claim 48, wherein said embedded device is capable of delivering real time response.

52. The embedded device in claim 48, wherein said embedded device is capable of functioning as a device.

53. The embedded device in claim 48, wherein said embedded device is capable of operating without an operating system.

54. The embedded device in claim 48, wherein said embedded device is capable of creating a template, said template being then compiled and loaded into said embedded device, said template capable of specifying protocol, content, data, and being a scripting language to translate inbound requests.

55. The embedded device in claim 48, wherein said embedded device is capable of running without human intervention once an initial configuration is completed.

56. The embedded device in claim 48, wherein said dynamic internet streaming engine is specifically designed to facilitate rapid application development and web site prototyping.

57. The embedded device in claim 48, wherein said dynamic internet streaming engine includes IP level security features.

58. The embedded device in claim 48, wherein said dynamic internet streaming engine allows developers to quickly add or change features without the need for code changes.

59. The embedded device in claim 48, wherein said dynamic internet streaming engine is capable of enabling said embedded device to deliver dynamic text and binary data stream editing for performing complex actions and making interactive web.

60. The embedded device in claim 48, wherein said dynamic internet streaming engine is capable of propagating changes made in one place instantly to thousands of files.

61. The embedded device in claim 48, wherein said dynamic internet streaming engine is capable of compiling code directly into HTML.

62. The embedded device in claim 48, wherein said dynamic internet streaming engine is capable of facilitating rapid application development and web site prototyping.

63. The embedded device in claim 48, wherein said security key generating application is capable of generating security keys based on a mathematical and biological equation.

64. The embedded device in claim 48, wherein said security keys are unique and random.

65. The embedded device in claim 48, wherein said object-oriented language allows access to preprocess directives from both C++ code and HTML code.

66. An embedded web server capable of managing dynamic content delivery of data stream, said embedded web server comprising:
means for receiving a data stream from a first disk or a first network;
means for processing said data stream;
means for memorizing said data stream;
means for enabling said embedded web server to perform complex actions;
means for saving said data stream to a second disk;
means for sending said data stream to a second network; and
means for producing a session identifier, said means for producing said session identifier capable of generating said session identifiers being never repeating within certain period of time and difficult to guess, said means for producing said session identifier comprising a character-generating application, said character-generating application existing as a single task in said embedded web server, said character-generating application comprising a character generator, a random generator connecting to said character generator, a temporal reference storage connecting to said character generator, said temporal reference storage storing the most current time information, and a key-pool group connecting to said character generator, said key-pool group including any or all of a first kind of key with a first kind of pool, a second kind of key with a second kind of pool, and a third kind of key with a third kind of pool, said character generator capable of generating a character set, said character set having thirty-two different characters, based on a geometric progression of x(n)=p(x(n−1)+i), said geometric progression manifesting itself as a chaotic progression of orbits around an origin, said orbit being defined as a unique and continuous path around said origin and never crossing in on itself or any other orbit, said x(n) and said x(n−1) representing different character sets, said n representing the number of said character sets generated by said character-generating server, said i representing a temporal difference between the time when two sequential orbits cross an arbitrary infinite vector from said origin, said p representing a period, said period being the temporal difference between character sets along any of said orbits, said geometric progression defining thirty-two periods on any of said orbit, said character set being a first kind of character set, a second kind of character set or a third kind of character set, and
an external timer device, said external timer device connecting to said character-generating application and capable of providing both a current time and a periodic tick of approximately one second to said character-generating application.

67. The embedded web server in claim 66, wherein said data stream includes audio stream and video stream.

68. The embedded web server in claim 66, wherein said first disk and said second disk can be one disk.

69. The embedded web server in claim 66, wherein said first network and said second network can be one network.

70. The embedded web server in claim 66, wherein said session identifier is assigned to said data stream when said means for saving said data stream saves said data stream to said second disk.

71. The embedded web server in claim 66, wherein said session identifier is assigned to said data stream when said means for sending said data stream to said second network.

72. The embedded web server in claim 66, wherein said means for enabling said embedded web server to perform complex actions is specifically designed to facilitate rapid application development and web site prototyping.

73. The embedded web server in claim 66, wherein said means for enabling said embedded web server to perform complex actions includes IP level security features.

74. The embedded web server in claim 66, wherein said means for enabling said embedded web server to perform complex actions allows developers to quickly add or change features without the need for code changes.

75. The embedded web server in claim 66, wherein said means for enabling said embedded web server to perform complex actions enables said embedded web server to deliver dynamic text and binary data stream editing for performing complex actions and making an interactive web.

76. The embedded web server in claim 66, wherein said means for enabling said embedded web server to perform complex actions is capable of propagating changes made in one place instantly to thousands of files.

77. The embedded web server in claim 66, wherein said means for enabling said embedded web server to perform complex actions is capable of compiling code directly into HTML.

78. The embedded web server in claim 66, wherein said means for enabling said embedded web server to perform complex actions is capable of facilitating rapid application development and web site prototyping.

79. The embedded web server in claim 66, wherein said means for producing said secured session identifier is capable of generating said secured session identifier based on a mathematical and biological equation.

80. The embedded web server in claim 66, wherein said secured session identifier is unique and random.

81. The embedded web server in claim 66, wherein said embedded web server is capable of running high-performance electronic commerce web sites.

82. The embedded web server in claim 66, wherein said embedded web server is capable of embedding and securing data, content, protocols and scripts.

83. The embedded web server in claim 66, wherein said embedded web server is capable of delivering real time response.

84. The embedded web server in claim 66, wherein said embedded web server is capable of functioning as a web server.

85. The embedded web server in claim 66, wherein said embedded web server is capable of operating without an operating system.

86. The embedded web server in claim 66, wherein said embedded web server is capable of creating a template, said template being then compiled and loaded into said embedded web server, said template capable of specifying protocol, content, data, and being a scripting language to translate inbound requests.

87. The embedded web server in claim 66, wherein said embedded web server is capable of running without human intervention once an initial configuration being completed.

88. The embedded web server in claim 66, wherein said random generator makes a pseudo random number required by said character generator to select a position on said orbit.

89. The embedded web server in claim 66, wherein said first kind of pool is a list of first kind of mapping positions in said first kind of key, said first kind of mapping position is marked “used” each time said character-generating server makes a character from said first kind of key.

90. The embedded web server in claim 66, wherein said second kind of pool is a list of second kind of mapping positions in said second kind of key, said second kind of mapping position is marked “used” each time said character-generating server makes a character from said second kind of key.

91. The embedded web server in claim 66, wherein said third kind of pool comprises a double primary pool and a double rotating pool, said third kind of key comprises a primary key and a rotating key, said double primary pool is a list of primary mapping positions in said primary key, said double rotating pool is a list of rotating mapping positions in said rotating key, said primary mapping position is marked “used” each time said character-generating server makes a character from said primary key, and said rotating mapping position is marked “used” each time said character-generating server makes a character from said rotating key.

92. The embedded web server in claim 66, wherein said character-generating server clears said pool each time said pool is full, or every one second, whichever comes first.

93. The embedded web server in claim 66, wherein said character-generating server is capable of generating 1,065,151,899,408 said first kind of character sets every one second.

94. The embedded web server in claim 66, wherein said character-generating server is capable of generating thirty-two said second kind of character sets every one second.

95. The embedded web server in claim 66, wherein said character-generating server is capable of generating 1024 said third kind of character sets every one second.

96. The embedded web server in claim 66, wherein said first kind of character set is easier to guess than either said second kind of character set or said third kind of character set.

97. The embedded web server in claim 66, wherein said second kind of character set is guaranteed to not repeat for twenty-eight years from the activation of the character-generating server.

98. The embedded web server in claim 66, wherein said third kind of character set is an extension of a second kind of character set in the sense that it will not repeat for twenty-eight years, said third kind of character set is simpler to guess than said second kind of character set.
